(19) United States
(12) Patent Application Publication
(10) Pub. No.: US 2007/0206879 A1
(43) Pub. Date: Sep. 6, 2007

(54) IMAGE SYNTHESIZER AND IMAGE SYNTHESIZING METHOD FOR THE SAME

(75) Inventor: Takashi Katou, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 11/677,375

(22) Filed: Feb. 21, 2007

(30) Foreign Application Priority Data
Feb. 22, 2006 (JP) 2006-045756

(51) Int. Cl. G06K 9/36

(52) U.S. Cl. 382/284

(57) ABSTRACT

An image synthesizer according to an embodiment of the present invention includes: a plurality of computing units synthesizing first and second image information based on first and second factors corresponding to the first and second image information to output a third factor as a composition factor of the first and second factors and intermediate output information obtained by multiplying the third factor by third image information as composite image information of the first and second image information; a divider dividing the intermediate output information output from one of the plurality of computing units by the third factor to output the third image information, at least one of the plurality of computing units serving as a first computing unit receiving intermediate input information obtained by multiplying the first image information by the first factor as input information corresponding to the first image information.

### BACKGROUND OF THE INVENTION

1. Field of the Invention

The present invention relates to an image synthesizer and an image synthesizing method for the same. In particular, the invention relates to an image synthesizer and an image synthesizing method for the same that adopt an alpha blending technique of synthesizing plural images by using different weighting factors α for the plural images.

2. Description of Related Art

Hitherto, an alpha blending technique has been well known as a technique of synthesizing plural images. The alpha blending technique assigns weights to plural images by using a weighting factor α and combines the weighted images to thereby synthesize the images. An example of the alpha blending technique is described by T. Poter and T. Duff in “Compositing Digital Images”, SIGGRAPH, 1984, pp. 253-259. This technique is called “Poter-Duff compositing operation”.

A weighting factor α used in the Poter-Duff compositing operation is called α value or alpha value, which represents image opacity. In the present invention, this factor is referred to as an “alpha value”. The Poter-Duff compositing operation is described next. In the Poter-Duff compositing operation, an alpha value αₒᵤₜ and a pixel value Cₒᵤₜ of a composite image are derived from Expressions (1) and (2), respectively.
αₒᵤₜ=α_{SRC}+(1−α_{SRC})*α_{DST} (1)
αₒᵤₜ*Cₒᵤₜ=α_{SRC}*C₁+(1−α_{SRC})*α_{DST}*C₀ (2)
In the above Expressions, C₀ represents a pixel value of a background image, C₁ represents a pixel value of a foreground image, α_{DST} represents an alpha value of the background image, and α_{SRC} represents an alpha value of the foreground image. Here, provided that the alpha value α_{DST} of the background image C₀ is 1, and the background image is opaque, Expressions (1) and (2) are rearranged to Expressions (3) and (4).
αₒᵤₜ=α_{SRC}+(1−α_{SRC})=1 (3)
Cₒᵤₜ=α_{SRC}*C₁+(1−α_{SRC})*C₀ (4)
If α_{SRC}=0.3, the pixel value Cₒᵤₜ of the composite image includes 30% of the pixel value of the foreground image and 70% of the pixel value of the background image. That is, regarding the pixel value Cₒᵤₜ of the composite image calculated with the Poter-Duff compositing operation, the pixel value C₁ of the foreground image accounts for 30% of opacity, and the pixel value C₀ of the background image accounts for 70% of opacity. The composite image is obtained by combining the two images.

As understood from the above description, the alpha blending technique makes it possible to adjust opacity of each image based on an alpha value and synthesize the images each having the adjusted opacity. The alpha blending technique can be applied to a color image. For example, as for RGB color images, the alpha blending technique may be applied to each of R (red), G (green), and B (blue) components. As for YCbCr color images, the alpha blending technique may be applied to each of Y (luminance), Cb (chroma blue), and Cr (chroma red) components. An image synthesizing technique adopting such alpha blending technique is disclosed in Japanese Unexamined Patent Publication Nos. 2001-285749 and 2005-77522.

Further, in the case of synthesizing three or more images, two of the plural images are first combined with Expressions (3) and (4), and the resulting image and the third image are input and combined with Expressions (3) and (4). This operation is repeated to thereby synthesize the three or more images.

A conventional the image synthesizer 100 that realizes the aforementioned alpha blending technique is described next. FIG. 13 is a block diagram of the conventional the image synthesizer 100. As shown in FIG. 13, the image synthesizer 100 includes image generators 110, 120, and 140, a divider 130, and a display device 150. The image generator 110 outputs, for example, an alpha-multiplied pixel value α₁C₁ obtained by multiplying a pixel value obtained by synthesizing four images by an alpha value, and an alpha value α₁. The image generator 120 outputs a background image pixel value C₀. The divider 130 divides the input alpha-multiplied pixel value α₁C₁ by the alpha value α₁ to output a foreground image pixel value C₁. The image generator 140 outputs a pixel value Cₒᵤₜ of a composite image by use of the input background image pixel value C₀, foreground image pixel value C₁, and alpha value α₁ based on Expression (4). The display device 150 displays the pixel value Cₒᵤₜ of the composite image.

The image generator 110 is described in more detail below. FIG. 14 is a block diagram of internal units of the image generator 110. As shown in FIG. 14, the image generator 110 includes alpha blending computing units 111, 112, and 113, and dividers 114, 115, and 116. The alpha blending computing units 111, 112, and 113 each synthesize two input images based on an alpha value α and a pixel value C of each image to generate new alpha value and alpha-multiplied pixel value. The dividers 114, 115, and 116 each divide the input alpha-multiplied pixel value by the input alpha value to generate a pixel value; the pixel value is input to the next stage. Here, the image generator 140 of FIG. 13 includes one alpha blending computing unit and one divider as shown in FIG. 14 or includes one alpha blending computing unit of FIG. 14. A fixed value “1” is set to the alpha value of the background image.

That is, in the conventional alpha blending computing unit, the alpha-multiplied pixel value is divided by the output alpha value that outputs together with the alpha-multiplied pixel value, and normalizes the pixel value to be input to the next stage with the alpha value to thereby obtain a pixel value of a composite image.

However, the conventional alpha blending computing unit can output nothing but the alpha-multiplied pixel value. Hence, if a pixel value is sent to the next stage, it is necessary to generate a pixel value not multiplied with an alpha value. As a result, the alpha blending computing units each require a divider, leading to a problem of increasing the circuit size. In the case of synthesizing more images, a number of dividers are necessary, so this problem becomes more serious.

Further, even if pixel value of a composite image is successively calculated with a CPU (central processing unit), the calculated values are alpha-multiplied pixel values. Thus, the alpha-multiplied pixel values should be divided and normalized for subsequent composition. In general, the division takes more time to execute than the multiplication or addition. This causes a problem in that the processing time increases if computation is executed with a computation method used in the conventional alpha blending computing unit.

### SUMMARY OF THE INVENTION

An image synthesizer according to an aspect of the present invention includes: a plurality of computing units synthesizing first and second image information based on first and second factors corresponding to the first and second image information to output a third factor as a composition factor of the first and second factors and intermediate output information obtained by multiplying the third factor by third image information as composite image information of the first and second image information; a divider dividing the intermediate output information output from one of the plurality of computing units by the third factor to output the third image information, at least one of the plurality of computing units serving as a first computing unit receiving intermediate input information obtained by multiplying the first image information by the first factor as input information corresponding to the first image information.

According to the image synthesizer of the present invention, the computing unit outputs the third factor as the composition factor of the first and second factors, and the intermediate output information obtained by multiplying the third factor by the third image information as the composite image information of the first and second image information. However, at least one of the plurality of computing units is a first computing unit receiving intermediate input information obtained by multiplying the first image information by the first factor as input information corresponding to the first image information. Thus, since the first computing unit is used as the tandem-connected computing units, intermediate output information output from a computing unit at a previous stage can be used as intermediate input information of a computing unit at a subsequent stage as it is. Hence, the image synthesizer of the present invention can omit a divider that is provided between the tandem-connected computing units. Therefore, a divider that occupies a larger circuit area can be omitted, so a chip area or layout area of the image synthesizer can be reduced. In contrast, conventional image synthesizers should be provided with a divider between tandem-connected computing units.

An image synthesizing method according to another aspect of the invention includes: executing a plurality of synthesizing processes of synthesizing first and second image information based on first and second factors corresponding to the first and second image information to output a third factor as a composition factor of the first and second factors and intermediate output information obtained by multiplying the third factor by third image information as composite image information of the first and second image information; and dividing the intermediate output information output in one of the plurality of synthesizing processes by the third factor to output the third image information, at least one of the plurality of synthesizing processes being a first synthesizing process receiving intermediate input information obtained by multiplying the first image information by the first factor as input information corresponding to the first image information.

According to the image synthesizing method of the present invention, the synthesizing processes output a third factor as a composition factor of the first and second factors and intermediate output information obtained by multiplying the third factor by third image information as composite image information of the first and second image information. However, at least one of the plurality of synthesizing processes is a first synthesizing process receiving intermediate input information obtained by multiplying the first image information by the first factor as input information corresponding to the first image information. Thus, the first synthesizing process is executed as the second and subsequent processes, so intermediate output information output in a previous synthesizing process can be used as intermediate input information to be output in a subsequent synthesizing process as it is. Hence, the image synthesizing method of the present invention can omit the division executed between consecutive synthesizing processes. Hence, the time-consuming division can be omitted, so a period necessary for the image synthesizing processing can be shortened.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of an image synthesizer according to a first embodiment of the present invention;

FIG. 2 is a block diagram of an image synthesizer according to a second embodiment of the present invention;

FIG. 3 is a block diagram of another example of the image synthesizer of the second embodiment;

FIG. 4 is a block diagram of an image synthesizer according to a third embodiment of the present invention;

FIG. 5 is a block diagram of an image synthesizer according to a fourth embodiment of the present invention;

FIG. 6 is a block diagram of another example of the image synthesizer of the fourth embodiment;

FIG. 7 is a block diagram of an image synthesizer according to a fifth embodiment of the present invention;

FIG. 8 is a block diagram of an image synthesizer according to a sixth embodiment of the present invention;

FIG. 9 is a block diagram of another example of the image synthesizer of the sixth embodiment;

FIG. 10 is a block diagram of an image synthesizer according to a seventh embodiment of the present invention;

FIG. 11 is a block diagram of an image synthesizer according to an eighth embodiment of the present invention;

FIG. 12 is a flowchart of processings executed with a CPU of the image synthesizer of the eighth embodiment;

FIG. 13 is a block diagram of a conventional image synthesizer; and

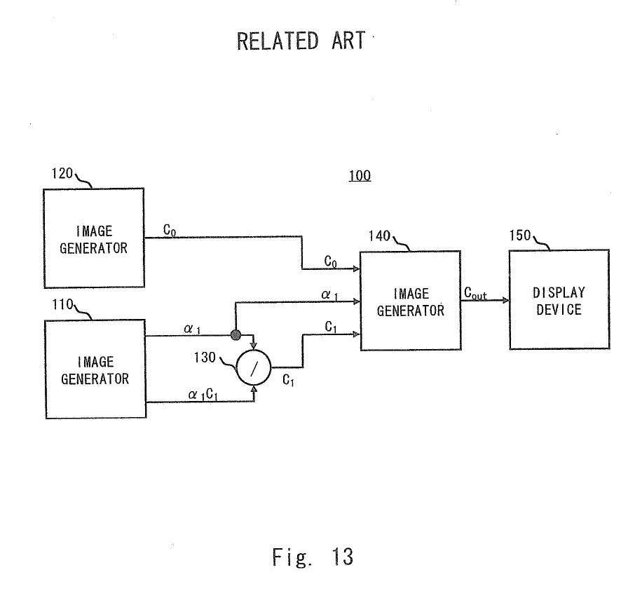

FIG. 14 is a detailed block diagram of a conventional image generator.

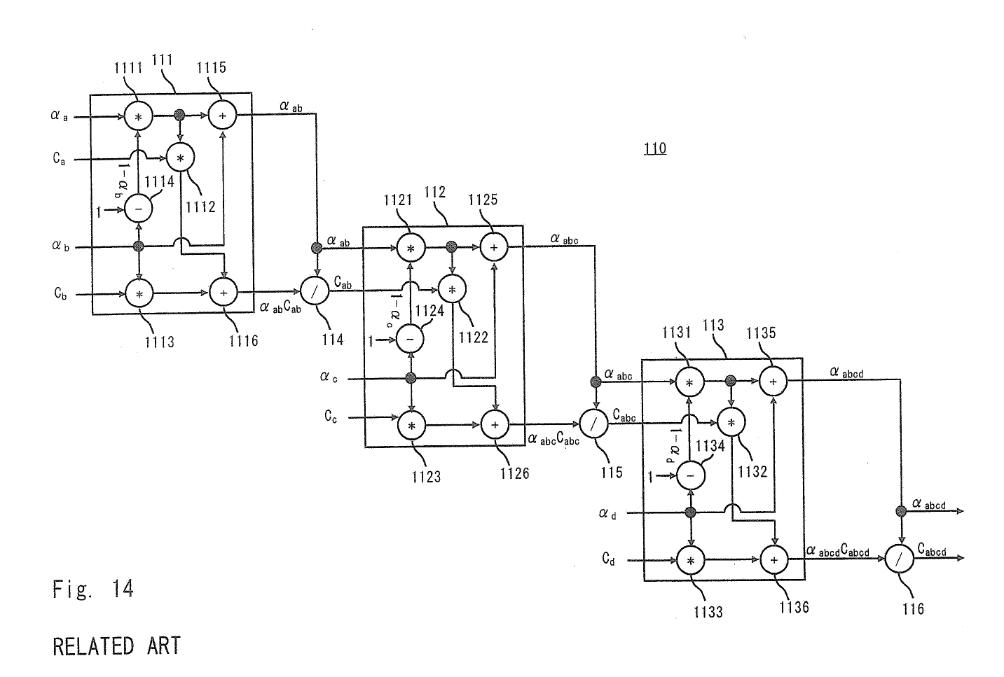

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

An image synthesizer 1 according to a first embodiment of the present invention synthesizes four images, images A, B, C, and D, for example and outputs the composite image. The respective images include information about an alpha value α representing image opacity and a pixel value C. An alpha blending computing unit used in the present invention combines, for example, first image information (for example, pixel value C₀ of a background image) and second image information (for example, pixel value C₁ of a foreground image) based on a first factor (for example, alpha value α₀ of the background image) and a second factor (for example, alpha value α₁ of the foreground image) to synthesize two images. Then, a third factor (for example, alpha value αₘᵢₓ of the composite image) obtained by synthesizing the alpha values α of the background image and the foreground image, and intermediate output information (for example, alpha-multiplied pixel value αₘᵢₓCₘᵢₓ) obtained by multiplying the alpha value αₘᵢₓ of the composite image by third image information (for example, pixel value Cₘᵢₓ of the composite image) obtained by synthesizing the pixel values of the background image and the foreground image.

Further, in this embodiment, plural pixels are synthesized using first and second computing units that execute computation in different ways. The second computing unit outputs the alpha value αₘᵢₓ of the composite image, and the alpha-multiplied pixel value αₘᵢₓCₘᵢₓ based on the alpha value α₀ and pixel value C₀ of the background image, and the alpha value α₁ and pixel value C₁ of the foreground image. The first computing unit outputs alpha value αₘᵢₓ of the composite image and the alpha-multiplied pixel value αₘᵢₓCₘᵢₓ based on the intermediate input information (for example, alpha-multiplied pixel value α₀C₀ of the background image), the alpha value α₀ of the background image, and the alpha value α₁ and pixel value C₁ of the foreground image.

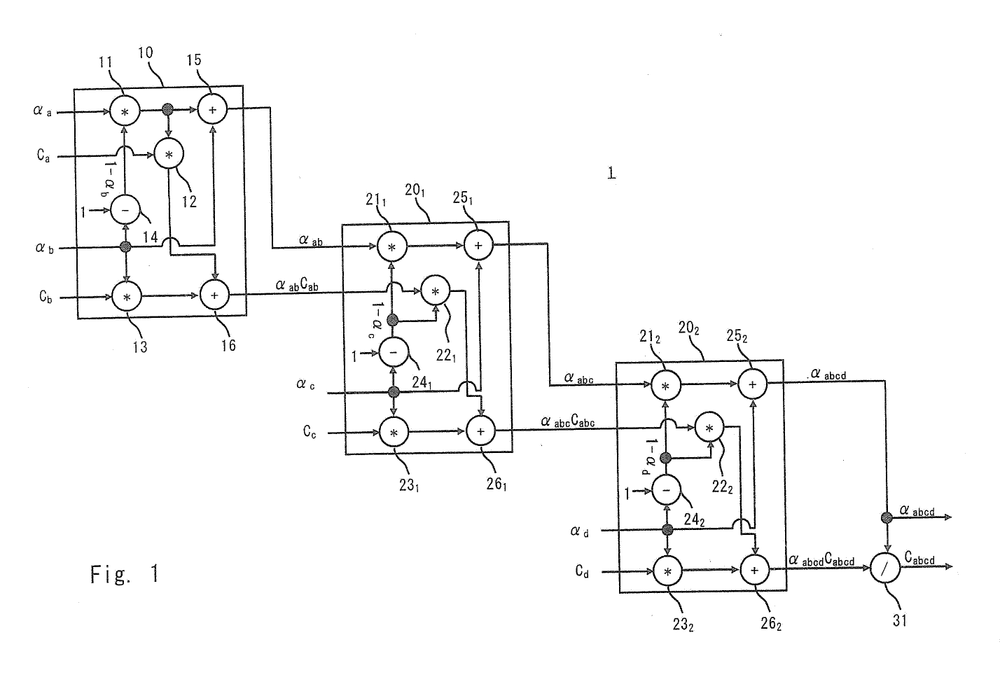

FIG. 1 is a block diagram of the image synthesizer 1. As shown in FIG. 1, the image synthesizer 1 includes a second computing unit (for example, alpha blending computing unit 10), a first computing unit (for example, alpha blending computing units 20₁ and 20₂), and a divider 31. The alpha blending computing units 10, 20₁, and 20₂ are arranged such that the alpha blending computing units 20₁ and 20₂ are connected in tandem with the alpha blending computing unit 10 at the first stage. An output of the alpha blending computing unit 20₂ at the last stage is connected with the divider 31.

The alpha blending computing unit 10 receives, as an alpha value α₀ and pixel value C₀ of the background image, an alpha value αₐ and pixel value Cₐ of the image A, and receives, as an alpha value α₁ and pixel value C₁ of the foreground image, an alpha value α_{b} and pixel value C_{b} of the image B. Further, as an alpha value αₘᵢₓ and alpha-multiplied pixel value αₘᵢₓCₘᵢₓ of the composite image, an alpha value cab and alpha-multiplied pixel value α_{ab}C_{ab} are output. The alpha blending computing unit 10 includes multipliers 11 to 13, a subtractor 14, and adders 15 and 16.

The multiplier 11 receives the alpha value αₐ of the image A and an output value of the subtractor 14 to output a result of multiplying the two values. The multiplier 12 receives the pixel value Cₐ of the image A and an output value of the multiplier 11 to output a result of multiplying the two values. The multiplier 13 receives the alpha value α_{b} and pixel value C_{b} of the image B to output a result of multiplying the two values. The subtractor 14 receives a value “1” and the alpha value α_{b} of the image B to output a value obtained by subtracting the alpha value α_{b} from the value “1”. The adder 15 receives an output value of the multiplier 11 and the alpha value α_{b} of the image B to output a result of adding the two values. The adder 16 receives an output value of the multiplier 12 and an output value of the multiplier 13 to output a result of adding the two values. Here, an output value of the adder 15 is the alpha value α_{ab} output from the alpha blending computing unit 10, and an output value of the adder 16 is the alpha-multiplied pixel value α_{ab}C_{ab} output from the alpha blending computing unit 10.

The alpha blending computing unit 20₁ receives, as an alpha value α₀ and alpha-multiplied pixel value α₀C₀ of the background image, an alpha value α_{ab} and alpha-multiplied pixel value α_{ab}C_{ab} of the alpha blending computing unit 10 at a previous stage, and receives an alpha value α₁ and pixel value C₁ of the foreground image, an alpha value α_{c} and pixel value C_{c} of the image C. Further, as an alpha value αₘᵢₓ and alpha-multiplied pixel value αₘᵢₓCₘᵢₓ of the composite image, an alpha value α_{abc} and alpha-multiplied pixel value α_{abc}C_{abc} are output. The alpha blending computing unit 20₁ includes multipliers 21₁ to 23₁, a subtractor 24₁, and adders 25₁ and 26₁.

The multiplier 21₁ receives the alpha value α_{ab} output from the alpha blending computing unit 10 and an output value of the subtractor 24₁ to output a result of multiplying the two values. The multiplier 22₁ receives the alpha-multiplied pixel value α_{abc}C_{abc} output from the alpha blending computing unit 10 and an output value of the subtractor 24₁ to output a result of multiplying the two values. The multiplier 23₁ receives the alpha value α_{c} and pixel value C_{c} of the image C to output a result of multiplying the two values. The subtractor 24₁ receives the value “1” and the alpha value α_{c} of the image C to output a result of subtracting the alpha value α_{c} from the value “1”. The adder 25₁ receives an output value of the multiplier 21₁ and the alpha value α_{c} of the image C to output a result of adding the two values. The adder 26₁ receives an output value of the multiplier 22₁ and an output value of the multiplier 23₁ to output a result of adding the two values. Here, an output value of the adder 25₁ is the alpha value α_{abc} output from the alpha blending computing unit 20₁, and an output value of the adder 26₁ is the alpha-multiplied pixel value α_{abc}C_{abc} output from the alpha blending computing unit 20₁.

The alpha blending computing unit 20₂ receives, as an alpha value α₀ and alpha-multiplied pixel value α₀C₀ of the background image, the alpha value α_{abc} and alpha-multiplied pixel value α_{abc}C_{abc} of the alpha blending computing unit 20₂ at the previous stage, and receives, as alpha value α₁ and pixel value C₁ of the foreground image, the alpha value α_{d} and pixel value C_{d} of the image D. Further, as the alpha value αₘᵢₓ and alpha-multiplied pixel value αₘᵢₓCₘᵢₓ of the composite image, the alpha value α_{abcd} and alpha-multiplied pixel value α_{abcd}C_{abcd} are output. The alpha blending computing unit 20₂ includes multipliers 21₂ to 23₂, a subtractor 24₂, and adders 25₂ and 26₂.

The multiplier 21₂ receives the alpha value α_{abc} output from the alpha blending computing unit 20₁ and an output value of the subtractor 24₂ to output a result of multiplying the two values. The multiplier 22₂ receives the alpha-multiplied pixel value α_{abc}C_{abc} output from the alpha blending computing unit 20₁ and an output value of the subtractor 24₂ to output a result of multiplying the two values. The multiplier 23₂ receives an alpha value α_{d} and pixel value C_{d} of the image D to output a result of multiplying the two values. The subtractor 24₂ receives the value “1” and the alpha value α_{d} of the image D to output a result of subtracting the alpha value α_{d} from the value “1”. The adder 25₂ receives an output value of the multiplier 21₂ and the alpha value α_{d} of the image D to output a result of adding the two values. The adder 26₂ receives an output value of the multiplier 22₂ and an output value of the multiplier 23₂ to output a result of adding the two values. Here, an output value of the adder 25₂ is the alpha value α_{abcd} output from the alpha blending computing unit 20₂, and an output value of the adder 26₂ is the alpha-multiplied pixel value α_{abcd}C_{abcd} output from the alpha blending computing unit 20₂. Further, the alpha value α_{abcd} output from the alpha blending computing unit 20₂ is output as an output alpha value of the image synthesizer 1 to another device.

The divider 31 receives the alpha-multiplied pixel value α_{abcd}C_{abcd} output from the alpha blending computing unit 20₂ and the alpha value α_{abcd} to output a result of dividing the alpha-multiplied pixel value α_{abcd}C_{abcd} by the alpha value α_{abcd} (pixel value C_{abcd}). The pixel value C_{abcd} is output as an output pixel value of the image synthesizer 1 to another device.

In the thus-connected units, the result of calculating output values of the alpha blending computing units and operations of the image synthesizer 1 are described next. Here, as for the images A, B, C, and D, the image A is assumed as the bottom image, and the images B, C, and D are superimposed on the image A in this order. First, the alpha blending computing unit 10 at the first stage receives the alpha value αₐ, pixel value Cₐ of the image A as one input image and receives the alpha value α_{b} and pixel value C_{b} of the image B as the other input image. Based on the input values, the subtractor 14 subtracts the alpha value α_{b} of the image B from the value “1” to output (1−α_{b}). The multiplier 11 multiplies an output value of the subtractor 14 by the alpha value αₐ of the image A to output ((1−α_{b})*αₐ). The adder 15 adds an output value of the multiplier 11 and the alpha value α_{b} of the image B to output (α_{b}+(1−α_{b})*αₐ). Accordingly, the alpha value α_{ab} output from the alpha blending computing unit 10 is expressed by Expression (5).
α_{ab}=α_{b}+(1−α_{b})*αₐ (5)

On the other hand, the multiplier 13 multiplies the alpha value α_{b} and pixel value C_{b} of the image B to output (α_{b}*C_{b}). The multiplier 12 multiplies an output value of the multiplier 11 by the pixel value Cₐ of the image A to output ((1−α_{b})*αₐ*Cₐ). The adder 16 adds an output value of the multiplier 12 and an output value of the multiplier 13 to output (α_{b}*C_{b}+(1−α_{b})*αₐ*Cₐ). Accordingly, the alpha-multiplied pixel value α_{ab}C_{ab} output from the alpha blending computing unit 10 is expressed by Expression (6).
α_{ab}C_{ab}=α_{b}*C_{b}+(1−α_{b})*αₐ*Cₐ (6)

Next, the alpha blending computing unit 20₁ at the second stage receives the alpha value α_{ab} output from the alpha blending computing unit 10, the alpha-multiplied pixel value α_{ab}C_{ab}, and the alpha value α_{c} and pixel value C_{c} of the image C. Based on the input values, the subtractor 24₁ subtracts the alpha value α_{c} of the image C from the value “1” to output (1−α_{c}). The multiplier 21₁ multiplies an output value of the subtractor 24₁ by the alpha value α_{ab} of the alpha blending computing unit 10 to output ((1−α_{c})*α_{ab}). The adder 25₁ adds an output value of the multiplier 21₁ and the alpha value α_{c} of the image C to output (α_{c}+(1−α_{c})*α_{ab}). Accordingly, the alpha value α_{abc} output from the alpha blending computing unit 20₁ is derived from Expression (7).

$$\begin{matrix}{α}_{abc} = {α}_{c} + ( 1 - {α}_{c} ) * {α}_{ab} \\ = {α}_{c} + ( 1 - {α}_{c} ) * {α}_{b} + ( 1 - {α}_{c} ) * ( 1 - {α}_{b} ) * {α}_{a}\end{matrix} \qquad ( 7 )$$

On the other hand, the multiplier 23₁ multiplies the alpha value α_{c} and pixel value C_{c} of the image C to output (α_{c}*C_{c}). The multiplier 22₁ multiplies the alpha-multiplied pixel value α_{ab}C_{ab} output from the output from the alpha blending computing unit 10 by an output value of the subtractor 24₁ to output ((1−α_{c})*α_{ab}C_{ab}). The adder 26₁ adds an output value of the multiplier 22₁ and an output value of the multiplier 23₁ to output (α_{c}*C_{c}+(1−α_{c})*α_{ab}C_{ab}) Accordingly, the alpha-multiplied pixel value α_{abc}C_{abc} output from the alpha blending computing unit 20₁ is derived from Expression (8).

$$\begin{matrix}{α}_{abc} {C}_{abc} = {α}_{c} * {C}_{c} + ( 1 - {α}_{c} ) * {α}_{ab} {C}_{ab} \\ = {α}_{c} * {C}_{c} + ( 1 - {α}_{c} ) * {α}_{b} * {C}_{b} + \\ ( 1 - {α}_{c} ) * ( 1 - {α}_{b} ) * {α}_{a} * {C}_{a}\end{matrix} \qquad ( 8 )$$

Next, the alpha blending computing unit 20₂ at the third stage receives the alpha value α_{abc} output from the alpha blending computing unit 20₁, the alpha-multiplied pixel value α_{abc}C_{abc}, and the alpha value α_{d} and pixel value C_{d} of the image D. Based on the input values, the subtractor 24₂ subtracts the alpha value α_{d} of the image D from the value “1” to output (1−α_{d}). The multiplier 21₂ multiplies an output value of the subtractor 24₂ by the alpha value α_{abc} of the alpha blending computing unit 20₁ to output ((1−α_{d})*α_{abc}). The adder 25₂ adds an output value of the multiplier 21₂ and the alpha value α_{d} of the image D to output (α_{d}+(1−α_{d})*α_{abc}). Accordingly, the alpha value α_{abcd} output from the alpha blending computing unit 20₂ is expressed by Expression (9).

$$\begin{matrix}{α}_{abcd} = {α}_{d} + ( 1 - {α}_{d} ) * {α}_{abc} \\ = {α}_{d} + ( 1 - {α}_{d} ) * {α}_{c} + ( 1 - {α}_{d} ) * ( 1 - {α}_{c} ) * {α}_{ab} \\ = {α}_{d} + ( 1 - {α}_{d} ) * {α}_{c} + ( 1 - {α}_{d} ) * ( 1 - {α}_{c} ) * {α}_{b} + \\ ( 1 - {α}_{d} ) * ( 1 - {α}_{c} ) * ( 1 - {α}_{b} ) * {α}_{a}\end{matrix} \qquad ( 9 )$$

On the other hand, the multiplier 23₂ multiplies the alpha value α_{d} and pixel value C_{d} of the image D to output (α_{d}*C_{d}). The multiplier 22₂ multiplies the alpha-multiplied pixel value α_{abc}C_{abc} output from the alpha blending computing unit 20₁ by an output value of the subtractor 24₂ to output ((1−α_{d})*α_{abc}C_{abc}). The adder 26₂ adds an output value of the multiplier 22₂ and an output value of the multiplier 23₂ to output (α_{d}*C_{d}+(1−α_{d})*α_{abc}C_{abc}). Accordingly, the alpha-multiplied pixel value α_{abcd}C_{abcd} output from the alpha blending computing unit 20₁ is derived from Expression (10).

$$\begin{matrix}{α}_{abcd} {C}_{abcd} = {α}_{d} * {C}_{d} + ( 1 - {α}_{d} ) * {α}_{abc} {C}_{abc} \\ = {α}_{d} * {C}_{d} + ( 1 - {α}_{d} ) * {α}_{c} * {C}_{c} + \\ ( 1 - {α}_{d} ) * ( 1 - {α}_{c} ) * {α}_{ab} {C}_{ab} \\ = {α}_{d} * {C}_{d} + ( 1 - {α}_{d} ) * {α}_{c} * {C}_{c} + \\ ( 1 - {α}_{d} ) * ( 1 - {α}_{c} ) * {α}_{b} * {C}_{b} + \\ ( 1 - {α}_{d} ) * ( 1 - {α}_{c} ) * ( 1 - {α}_{b} ) * {α}_{c} * {C}_{a}\end{matrix} \qquad ( 10 )$$

The divider 31 divides the thus-calculated alpha-multiplied pixel value α_{abcd}C_{abcd} by the alpha value c. Thus, a pixel value C_{abcd} as the final output value of the image synthesizer 1 is obtained.

As described above, according to the image synthesizer 1 of this embodiment, the second computing unit at the first stage (for example, alpha blending computing unit 10) synthesizes the image A and the image B to output the alpha value α_{ab} and alpha-multiplied pixel value α_{ab}C_{ab} of the composite image of the images A and B.

Further, the first computing unit (for example, alpha blending computing unit 20₁) is connected in tandem with the alpha blending computing unit 10. The alpha blending computing unit 20₁ receives the alpha value α_{ab} and alpha-multiplied pixel value α_{ab}C_{ab} of the composite image output from the alpha blending computing unit 10 as one input image information. Further, as the other input image information, the alpha value α_{c} and pixel value C_{c} of the image C are input.

As apparent from the above Expression (7), the alpha blending computing unit 20₁ outputs the alpha value α_{abc} of the composite image obtained by synthesizing the images A, B, and C based on the alpha value α_{ab} of the composite image output from the alpha blending computing unit 10 and the alpha value α_{c} of the image C. Further, as apparent from the above Expression (8), the alpha blending computing unit 20₁ outputs the alpha-multiplied pixel value α_{abc}C_{abc} of the composite image of the images A, B, and C based on the alpha-multiplied pixel value α_{ab}C_{ab} of the composite image output from the alpha blending computing unit 10 and the alpha value α_{c} and pixel value C_{c} of the image C.

That is, in the case of generating an alpha-multiplied pixel value αC to be output, the alpha blending computing unit 20₁ uses an alpha-multiplied pixel value out of input image information and does not take an alpha value corresponding to the alpha-multiplied pixel value into consideration. Thus, the alpha-multiplied pixel value αC output from the alpha blending computing unit at the previous stage can be directly received. This makes it possible to dispense with a divider that needs to be provided between tandem-connected alpha blending computing units in the conventional technique. The alpha blending computing unit of the present invention includes no divider. Accordingly, the number of dividers the circuit size of which is larger than that of the computing unit can be reduced in the entire image synthesizer, and a layout area or chip area of the image synthesizer can be reduced.

Further, the alpha blending computing unit 20₂ connected with the alpha blending computing unit 20₁ receives, similar to the alpha blending computing unit 20₁, the alpha value α_{abc} and alpha-multiplied pixel value α_{abc}C_{abc} of the composite image as one input information and receives the alpha value α_{d} and pixel value C_{d} of the image D as the other input information. Based on the input values, the alpha blending computing unit 20₂ outputs the alpha value α_{abcd} and alpha-multiplied pixel value α_{abcd}C_{abcd} of the composite image of the images A, B, C, and D as expressed by above Expressions (9) and (10). In this embodiment, the alpha blending computing unit 20₂ is at the last stage, so its output is connected with the divider 31. The divider 31 generates and outputs the pixel value C_{abcd} to be output from the image synthesizer 1 based on an output value of the alpha blending computing unit 20₂. Here, the alpha value α_{abcd} output from the alpha blending computing unit 20₂ is output as an alpha value of an image synthesized with the image synthesizer 1 as it is.

Accordingly, the image synthesizer 1 of this embodiment has only to provide a divider at the last stage and can reduce the number of dividers as compared with the conventional image synthesizer. This beneficial effect is enhanced if many images are synthesized and the number of alpha blending computing units connected in tandem is increased.

### Second Embodiment

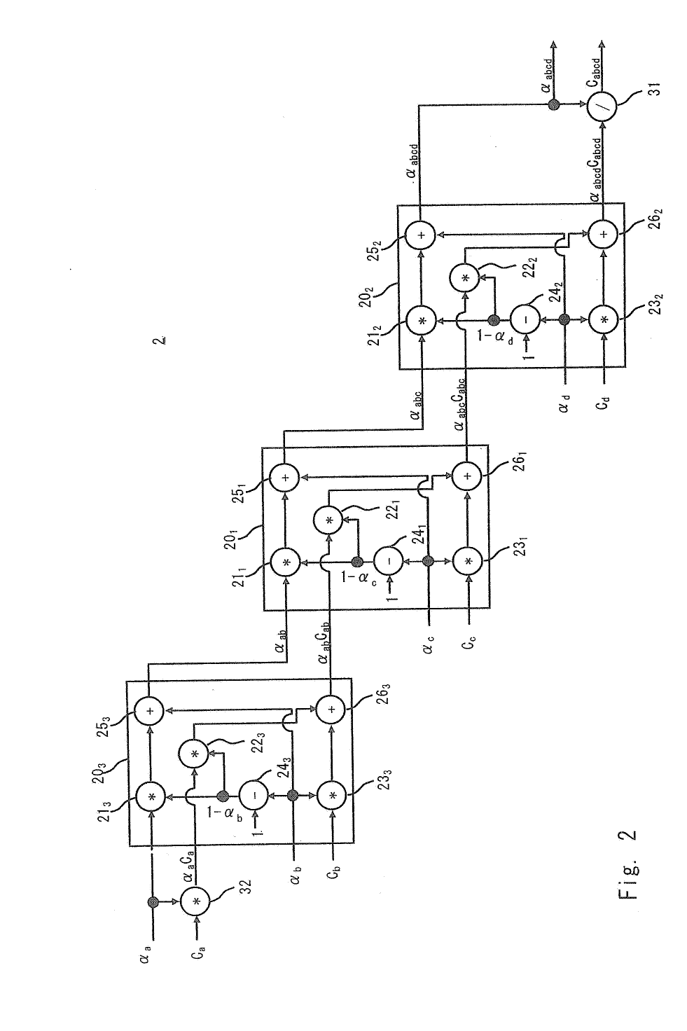

FIG. 2 shows an image synthesizer 2 according to a second embodiment of the present invention. Although the image synthesizer 1 of the first embodiment provides the second computing unit at the first stage, the image synthesizer 2 of the second embodiment provides the first computing unit at the first stage. In the second embodiment, the same components as those of the first embodiment are denoted by like reference numerals, and description thereof is omitted here.

As shown in FIG. 2, the image synthesizer 2 of the second embodiment includes the first computing unit at the first stage (for example, alpha blending computing unit 20₃). Further, the image A is input to the alpha blending computing unit 20₃ through the multiplier 32. The multiplier 32 multiplies the alpha value αₐ and pixel value Cₐ of the image A to generate an alpha-multiplied pixel value αₐCₐ of the image A. The alpha-multiplied pixel value αₐCₐ and alpha value αa are input as one input information and the alpha value α_{b} and pixel value C_{b} of the image B as the other input information, and the alpha blending computing unit 20₃ outputs the alpha value α_{ab} and alpha-multiplied pixel value α_{ab}C_{ab} of the composite image of the images A and B. The alpha value α_{ab} and alpha-multiplied pixel value α_{ab}C_{ab} output from the alpha blending computing unit 20₃ are expressed by Expressions (11) and (12).
α_{ab}=α_{b}+(1−α_{b})*αₐ (11)
α_{ab}C_{ab}=α_{b}*C_{b}+(1−α_{b})*αₐ*Cₐ (12)

As apparent from Expressions (11) and (12), an output of the alpha blending computing unit 20₃ at the first stage of the image synthesizer 2 of the second embodiment is the same as that of the alpha blending computing unit 10 at the first stage of the image synthesizer 1 of the first embodiment. The alpha blending computing unit 20₁ and 20₂, and the divider 31 are connected with the alpha blending computing unit 20₃ in the same manner as the first embodiment. Hence, an output value of the image synthesizer 2 of the second embodiment is similar to that of the first embodiment.

As understood from the above description, according to the image synthesizer 2 of the second embodiment, the first computing units are connected in tandem to realize an output value similar to that of the image synthesizer 1 of the first embodiment. Further, the tandem-connected computing units are the first computing units, and the same circuits can be used at the stage of the circuit design or chip layout, making it possible to simplify the circuit design and chip layout.

Further, also in the image synthesizer 2 of the second embodiment, it is unnecessary to provide a divider between the alpha blending computing units and inside the alpha blending computing unit. Hence, it is possible to save a layout area or chip area for the divider similar to the first embodiment.

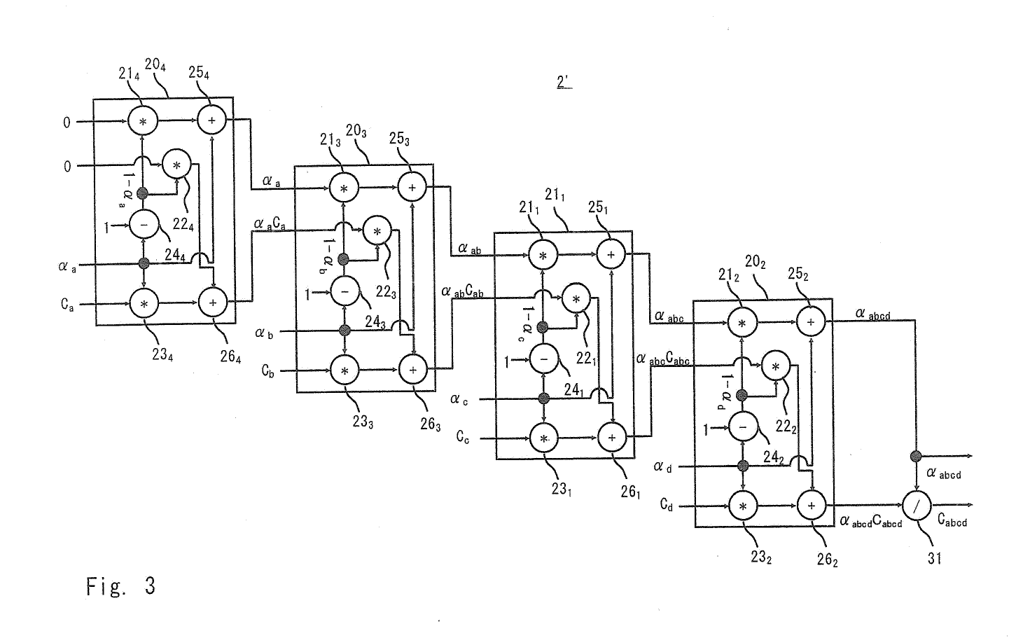

FIG. 3 shows another example of the image synthesizer 2 of the second embodiment. An image synthesizer 2′ of FIG. 3 uses the first computing unit (for example, alpha blending computing unit 20₄) in place of the multiplier 32 of the image synthesizer 2. The alpha blending computing unit 20₄ does not receive the alpha value α and the image value C as one input information (as expressed by value “0” in FIG. 3) and receives the alpha value αₐ and pixel value Cₐ of the image A as the other input information. Thus, the alpha value α₂₀₄ and alpha-multiplied pixel value α₂₀₄C₂₀₄ output from the alpha blending computing unit 20₄ are expressed by Expressions (13) and (14).

$$\begin{matrix}\begin{matrix}{α}_{204} = {α}_{a} + ( 1 - {α}_{a} ) * 0 \\ = {α}_{a}\end{matrix} & ( 13 ) \\ \begin{matrix}{α}_{204} {C}_{204} = {α}_{a} * {C}_{α} + ( 1 - {α}_{a} ) * 0 * 0 \\ = {α}_{a} * {C}_{a}\end{matrix} & ( 14 )\end{matrix}$$

That is, the alpha value α₂₀₄ and alpha-multiplied pixel value α₂₀₄C₂₀₄ output from the alpha blending computing unit 20₄ become the alpha value αₐ and alpha-multiplied pixel value αₐCₐ of the image A. Accordingly, the alpha blending computing unit 20₃, 20₁ and 20₂, and the divider 31 are connected in tandem with the alpha blending computing unit 20₄ similar to the image synthesizer 2 to realize an output value similar to that of the image synthesizer 1 of the first embodiment.

Further, in the image synthesizer 2, the multiplier 32 is necessary in addition to the alpha blending computing unit, but in the image synthesizer 2′, the alpha blending computing unit of the same configuration as those of the units is used in place of the multiplier 32. Thus, the design of the image synthesizer 2′ can be simpler than that of the image synthesizer 2.

### Third Embodiment

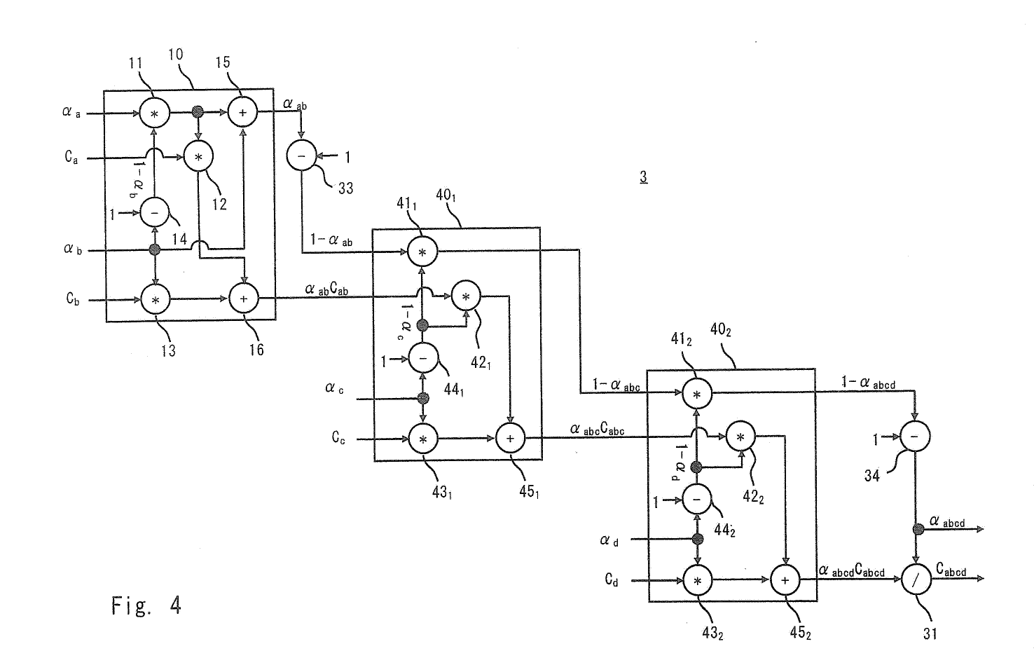

FIG. 4 is a block diagram of an image synthesizer 3 according to a third embodiment of the present invention. As shown in FIG. 4, the image synthesizer 3 of the third embodiment differs from the image synthesizer 1 of the first embodiment in terms of tandem-connected alpha blending computing units at second and subsequent stages. In this embodiment, as the tandem-connected first computing units at the second and subsequent stages, the alpha blending computing units 40₁ and 40₂ are used. The first computing unit of this embodiment receives, as one input information, a result of subtracting the alpha value α from the value “1” (1−α) and the alpha-multiplied pixel value αC and receives, as the other input information, the alpha value α and pixel value C. Further, the first computing unit of this embodiment outputs, based on the input values, a result of subtracting the alpha value αₘᵢₓ from the value “1” (1−αₘᵢₓ) and the alpha-multiplied pixel value αₘᵢₓCₘᵢₓ of the composite image.

Here, in the image synthesizer 3 of this embodiment, the alpha value α_{ab} output from the output from the alpha blending computing unit 10 at the first stage is input as an alpha value corresponding to one input image to the alpha blending computing unit 40₁ at the second stage through the subtractor 33. The subtractor 33 outputs a result of subtracting the alpha value α_{ab} from the value “1”.

The first computing unit of this embodiment is described in detail next. As the first computing unit, the alpha blending computing unit 40₁ is described by way of example. The alpha blending computing unit 40₁ includes multipliers 41₁, 42₁, and 43₁, a subtractor 44₁, and an adder 45₁. The alpha blending computing unit 40₁ receives, as an alpha value α and alpha-multiplied pixel value αC corresponding to one input image, the value (1−α_{ab}) and alpha-multiplied pixel value α_{ab}C_{ab}. Further, the alpha blending computing unit 40₁ receives, as an alpha value α and pixel value C corresponding to the other input image, the alpha value α_{c} and pixel value C_{c} of the image C.

The alpha blending computing unit 40₁ outputs a result of subtracting the alpha value α_{c} of the image C from the value “1” (1−α_{c}) with the subtractor 44₁. The multiplier 41₁ multiplies an output value of the subtractor 44₁ by the value (1−α_{ab}) input as one input image value to output the multiplied value. The output value is an alpha value to be output from the alpha blending computing unit 40₁ as the value (1−α_{abc}). The value (1−α_{abc}) is expressed by Expression (15) below.

$$\begin{matrix}1 - {α}_{abc} = ( 1 - {α}_{c} ) * ( 1 - {α}_{ab} ) \\ = 1 - \{ {α}_{c} + ( 1 - {α}_{c} ) * {α}_{ab} \} \\ = 1 - \{ {α}_{c} + ( 1 - {α}_{c} ) * {α}_{b} + ( 1 - {α}_{c} ) * ( 1 - {α}_{b} ) * {α}_{a} \}\end{matrix} \qquad ( 15 )$$

Further, the multiplier 42₁ multiplies an output value of the subtractor 44₁ by the alpha-multiplied pixel value α_{ab}C_{ab} input as one input image to output the multiplied value. The multiplier 43₁ multiplies the alpha value α_{c} and pixel value C_{c} of the image C to output the multiplied value. The adder 45₁ adds an output value of the multiplier 42₁ and an output value of the multiplier 43₁ to output the added value. The an output value of the adder 45₁ becomes an alpha-multiplied pixel value α_{abc}C_{abc} to be output from the alpha blending computing unit 40₁. The alpha-multiplied pixel value α_{abc}C_{abc} is expressed by Expression (16) below.

$$\begin{matrix}{α}_{abc} {C}_{abc} = {α}_{c} * {C}_{c} + ( 1 - {α}_{c} ) * {α}_{ab} {C}_{ab} \\ = {α}_{c} * {C}_{c} + ( 1 - {α}_{c} ) * {α}_{b} * {C}_{b} + \\ ( 1 - {α}_{c} ) * ( 1 - {α}_{b} ) * {α}_{a} * {C}_{a}\end{matrix} \qquad ( 16 )$$

Next, the alpha blending computing unit 40₂ connected in tandem with the alpha blending computing unit 40₁ has the same configuration as that of the alpha blending computing unit 40₁. Further, the alpha blending computing unit 40₂ receives, as the alpha value α and alpha-multiplied pixel value αC corresponding to one input image, the value (1−α_{abc}) and alpha-multiplied pixel value α_{abc}C_{abc}. Further, the alpha blending computing unit 40₂ receives, as alpha value α and pixel value C corresponding to the other input image, the alpha value α_{d} and pixel value C_{d} of the image D. The alpha blending computing unit 40₂ outputs, based on the input values, the alpha value (1−α_{abcd}) and alpha-multiplied pixel value α_{abcd}C_{abcd}. The alpha value (1−α_{abcd}) and alpha-multiplied pixel value α_{abcd}C_{abcd} are expressed by Expressions (17) and (18) below.

$$\begin{matrix}\begin{matrix}1 - {α}_{abcd} = ( 1 - {α}_{d} ) * ( 1 - {α}_{abc} ) \\ = 1 - \{ {α}_{d} + ( 1 - {α}_{d} ) * {α}_{abc} \} \\ = 1 - \{ {α}_{d} + ( 1 - {α}_{d} ) * {α}_{c} + ( 1 - {α}_{d} ) * ( 1 - {α}_{c} ) * {α}_{ab} \} \\ = 1 - \{ \begin{matrix}{α}_{d} + ( 1 - {α}_{d} ) * {α}_{c} + ( 1 - {α}_{d} ) * \\ {α}_{b} + ( 1 - {α}_{d} ) * ( 1 - {α}_{c} ) * ( 1 - {α}_{ b} ) * {α}_{ a}\end{matrix} \}\end{matrix} & ( 17 ) \\ \begin{matrix}{α}_{abcd} {C}_{abcd} = {α}_{d} * {C}_{d} + ( 1 - {α}_{d} ) * {α}_{ abc} {C}_{abc} \\ = {α}_{d} * {C}_{d} + ( 1 - {α}_{d} ) * {α}_{c} * {C}_{c} + \\ ( 1 - {α}_{d} ) * ( 1 - {α}_{c} ) * {α}_{ab} {C}_{ab} \\ = {α}_{d} * {C}_{d} + ( 1 - {α}_{d} ) * {α}_{c} * {C}_{c} + ( 1 - {α}_{d} ) * \\ ( 1 - {α}_{c} ) * {α}_{b} * {C}_{b} + ( 1 - {α}_{d} ) * ( 1 - {α}_{c} ) * \\ ( 1 - {α}_{b} ) * {α}_{a} * {C}_{a}\end{matrix} & ( 18 )\end{matrix}$$

The alpha value (1−α_{abcd}) output from the alpha blending computing unit 40₂ is input to the subtractor 34, and the alpha value (1−α_{abcd}) is subtracted from the value “1”. That is, an output value of the subtractor 34 is an alpha value α_{abcd}. The alpha value α_{abcd} is input to the divider 31 and then output as an alpha value of the image synthesizer 3.

As understood from the above description, in the image synthesizer 3 of the third embodiment, an alpha value corresponding to an input alpha-multiplied pixel value among the alpha values input to a computing unit at the first stage out of the tandem-connected first computing units is set to (1−α) by use of the subtractor, and an alpha value output from a computing unit at the last stage out of the tandem-connected first computing units is set to (1−α) by use of the subtractor. Thus, the image synthesizer 3 of the third embodiment can obtain an alpha value of a composite image similar to the image synthesizer of the first and second embodiments.

Accordingly, the image synthesizer 3 of the third embodiment can reduce the circuit size of the first computing unit (for example, alpha blending computing units 40₁ and 40₂) by an adder size as compared with the first computing unit of the first and second embodiments. That is, each alpha blending computing unit can be downsized, so the effect of reducing the circuit size is very large in the case of synthesizing a number of images.

### Fourth Embodiment

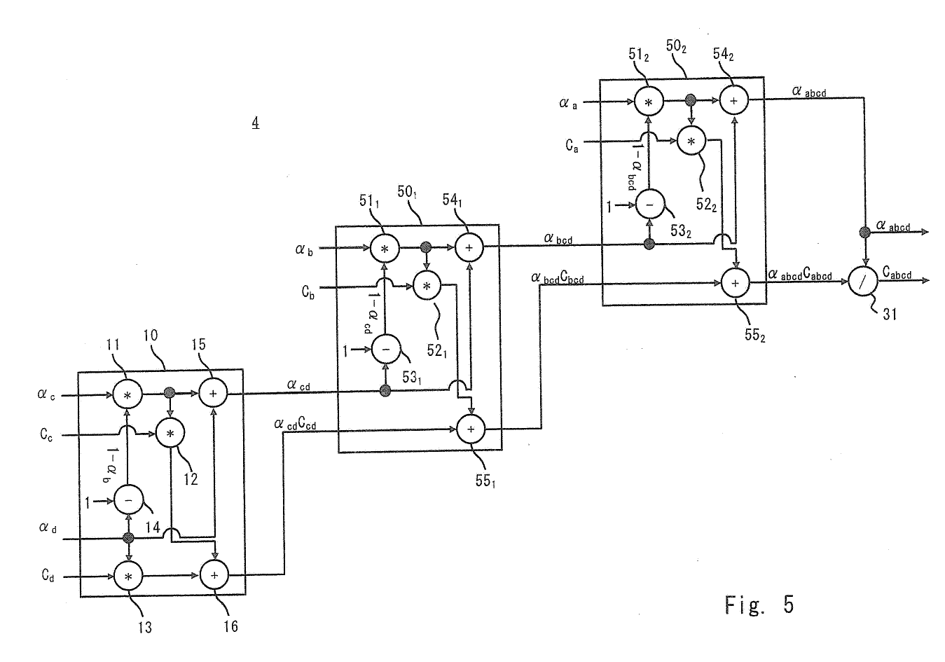

FIG. 5 is a block diagram of an image synthesizer 4 according to a fourth embodiment of the present invention. In the first to third embodiments, the image A is the bottom image, and the images B, C, and D are superimposed on the image A in this order. In contrast, in the fourth embodiment, the images C, B, and A are superimposed in the order on the image D as the bottom image. That is, the image synthesizer 4 of the fourth embodiment synthesizes, based on the top image, images as the background images.

As shown in FIG. 5, in the image synthesizer 4, the first computing unit (for example, alpha blending computing units 50₁ and 50₂) is connected in tandem with the second computing unit (for example, alpha blending computing unit 10). The alpha blending computing unit 10 outputs the alpha value α_{cd} and alpha-multiplied pixel value α_{cd}C_{cd} of the composite image of the image C and image D. The alpha blending computing unit 50₁ uses the alpha value α_{cd} and alpha-multiplied pixel value α_{cd}C_{cd} output from the alpha blending computing unit 10 as a first factor and first image information and uses the alpha value α_{b} and pixel value C_{b} of the image B as a second factor and second image information. Based on the above, the alpha blending computing unit 50₁ outputs the alpha value α_{bcd} and alpha-multiplied pixel value α_{bcd}C_{bcd} of the composite image of the images B, C, and D. The alpha blending computing unit 50₂ uses an output value of the alpha blending computing unit 50₁ to output the alpha value α_{abcd} and alpha-multiplied pixel value α_{abcd}C_{abcd} of the composite image of the images A, B, C, and D. An output of the alpha blending computing unit 50₂ is connected with the divider 31, and the alpha-multiplied pixel value α_{abcd}C_{abcd} is divided by the alpha value α_{abcd} to output the pixel value C_{abcd} of the composite image.

Here, the alpha blending computing unit 10 differs from that of the first embodiment only in terms of an input image, and an output alpha value α_{cd} and alpha-multiplied pixel value α_{cd}C_{cd} are expressed by Expressions (19) and (20).
α_{cd}=α_{d}+(1−α_{d})*α_{c}
α_{cd}C_{cd}=α_{d}*C_{d}+(1−α_{d})*α_{c}*C_{c} (20)

The alpha blending computing unit 10 is the same as that of the first embodiment, so its detailed description is omitted here. The alpha blending computing units 50₁ and 50₂ are detailed below. The alpha blending computing units 50₁ and 50₂ are the same, so the alpha blending computing unit 50₁ is explained by way of example.

The alpha blending computing unit 50₁ receives, as the alpha value α and pixel value C corresponding to one input image, the alpha value α_{b} and pixel value C_{b} of the image B. Further, the alpha blending computing unit 50₁ receives, as the alpha value α and alpha-multiplied pixel value αC corresponding to the other input image, the alpha value α_{cd} and alpha-multiplied pixel value α_{cd}C_{cd} output from the alpha blending computing units 10 at the previous and subsequent stages. The alpha blending computing unit 50₁ outputs, based on the input values, the alpha value α_{bcd} and alpha-multiplied pixel value α_{bcd}C_{bcd}.

The alpha blending computing unit 50₁ includes multipliers 51₁ and 52₁, a subtractor 53₁, and adders 54₁ and 55₁. The subtractor 53₁ subtracts the alpha value α_{cd} corresponding to the other input image from the value “1” to output the resultant. The multiplier 51₁ multiplies an output value of the subtractor 53₁ by the alpha value α_{b} of the image B to output the multiplied value. The adder 54₁ adds an output value of the multiplier 51₁ and the alpha value α_{cd} corresponding to the other input image to output the added value. An output value of the adder 54₁ becomes an alpha value α_{bcd} to be output from the alpha blending computing unit 50₁. The alpha value α_{bcd} is expressed by Expression (21) below.

$$\begin{matrix}{α}_{bcd} = {α}_{c d} + ( 1 - {α}_{c d} ) * {α}_{b} \\ = {α}_{d} + ( 1 - {α}_{d} ) * {α}_{c} + ( 1 - {α}_{d} ) * ( 1 - {α}_{c} ) * {α}_{b}\end{matrix} \qquad ( 21 )$$

Further, the multiplier 52₁ multiplies an output value of the multiplier 51₁ by the pixel value C_{b} of the image B to output the multiplied value. The adder 55₁ adds an output value of the multiplier 52₁ and the alpha-multiplied pixel value α_{cd}C_{cd} output from the alpha blending computing unit 10 to output the added value. An output value of the adder 55₁ becomes an alpha-multiplied pixel value α_{bcd}C_{bcd} to be output from the alpha blending computing unit 50₁. The alpha-multiplied pixel value α_{bcd}C_{bcd} is expressed by Expression (22) below.

$$\begin{matrix}{α}_{bcd} {C}_{bcd} = {α}_{c d} * {C}_{c d} + ( 1 - {α}_{c d} ) * {α}_{b} {C}_{b} \\ = {α}_{d} * {C}_{d} + ( 1 - {α}_{d} ) * {α}_{c} * {C}_{c} + ( 1 - {α}_{d} ) * \\ ( 1 - {α}_{c} ) * {α}_{b} * {C}_{b}\end{matrix} \qquad ( 22 )$$

On the other hand, the alpha blending computing unit 50₂ connected in tandem with the alpha blending computing unit 50₁ has the same configuration as that of the alpha blending computing unit 50₁. Further, the alpha blending computing unit 50₂ receives, as the alpha value α and pixel value C corresponding to one input image, the alpha value αₐ and pixel value Cₐ of the image A. Further, the alpha blending computing unit 50₂ receives, as the alpha value α and alpha-multiplied pixel value αC corresponding to the other input image, the alpha value α_{bcd} and alpha-multiplied pixel value α_{bcd}C_{bcd} output from the alpha blending computing unit 50₁. The alpha blending computing unit 50₂ outputs, based on the input values, the alpha value α_{abcd} and alpha-multiplied pixel value α_{abcd}C_{abcd}. The alpha value α_{abcd} and alpha-multiplied pixel value α_{abcd}C_{abcd} are expressed by Expressions (23) and (24) below.

$$\begin{matrix}\begin{matrix}{α}_{abcd} = {α}_{bcd} + ( 1 - {α}_{bcd} ) * {α}_{a} \\ = {α}_{d} + ( 1 - {α}_{d} ) * {α}_{c} + ( 1 - {α}_{d} ) * ( 1 - {α}_{c} ) * {α}_{b} + \\ ( 1 - {α}_{d} ) * ( 1 - {α}_{c} ) * ( 1 - {α}_{b} ) * {α}_{a}\end{matrix} & ( 23 ) \\ \begin{matrix}{α}_{abcd} {C}_{abcd} = {α}_{bcd} * {C}_{bcd} + ( 1 - {α}_{bcd} ) * {α}_{a} {C}_{a} \\ = {α}_{d} * {C}_{d} + ( 1 - {α}_{d} ) * {α}_{c} * {C}_{c} + ( 1 - {α}_{d} ) * \\ ( 1 - {α}_{c} ) * {C}_{b} + ( 1 - {α}_{d} ) * ( 1 - {α}_{c} ) * ( 1 - {α}_{b} ) * \\ {α}_{a} * {C}_{a}\end{matrix} & ( 24 )\end{matrix}$$

As apparent from the Expressions (23) and (24), in this embodiment as well, the alpha value α_{abcd} and alpha-multiplied pixel value α_{abcd}C_{abcd} output from the alpha blending computing unit 50₂ at the last stage are similar to those of the first embodiment. That is, according to this embodiment, even if images are rearranged and then synthesized, the images can be synthesized in the same way as the first embodiment.

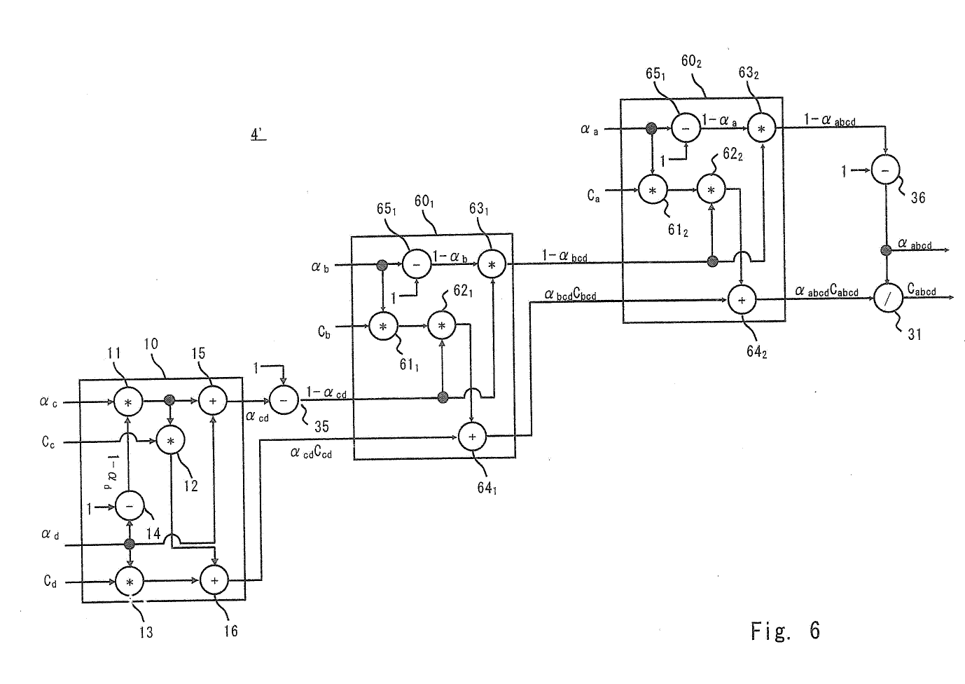

Further, FIG. 6 shows another example of this embodiment. An image synthesizer 4′ of FIG. 6 changes the image synthesizer 4 like the change of the image synthesizer 1 to the image synthesizer 3.

### Fifth Embodiment

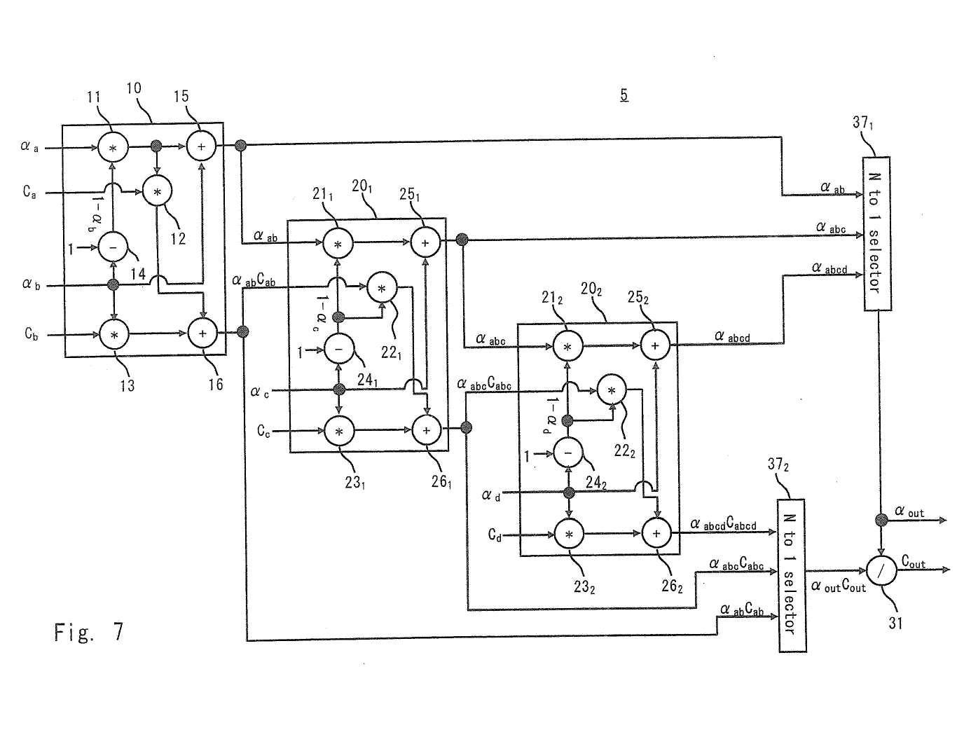

FIG. 7 is a block diagram of an image synthesizer 5 according to a fifth embodiment of the present invention. The image synthesizer 5 of the fifth embodiment includes first and second selectors (for example, selector 37₁ and 37₂) in addition to the components of the image synthesizer 1 of the first embodiment. The selector 37₁ receives alpha values α output from the alpha blending computing units, selects any one of the alpha values, and outputs the selected one as an alpha value αₒᵤₜ. Further, the selector 37₂ receives alpha-multiplied pixel values α_{C} from the alpha blending computing units, selects any one of the alpha-multiplied pixel values, and outputs the selected one as an alpha-multiplied pixel value αₒᵤₜCₒᵤₜ. Here, there is a correspondence between the alpha value output from the selector 37₁ and the alpha-multiplied pixel value selected with the selector 37₂.

An output value of the selectors 37₁ and 37₂ is input to the divider 31. The divider 31 divides the alpha-multiplied pixel value αₒᵤₜCₒᵤₜ output from the selector 37₂ by the value αₒᵤₜ output from the selector 37₁. Thus, the divider 31 generates a pixel value Cₒᵤₜ of the composite image to be output from the image synthesizer 5. Further, the alpha value αₒᵤₜ output from the selector 37₁ becomes an alpha value αₒᵤₜ to be output from the image synthesizer 5 as it is.

As understood from the above description, the image synthesizer 5 of the fifth embodiment can select a desired output value of the alpha blending computing units in accordance with the number of images to synthesize even if the number of images to synthesize is changed. Thus, even if the number of images to synthesize is changed, one image synthesizer 5 can output an appropriate value.

### Sixth Embodiment

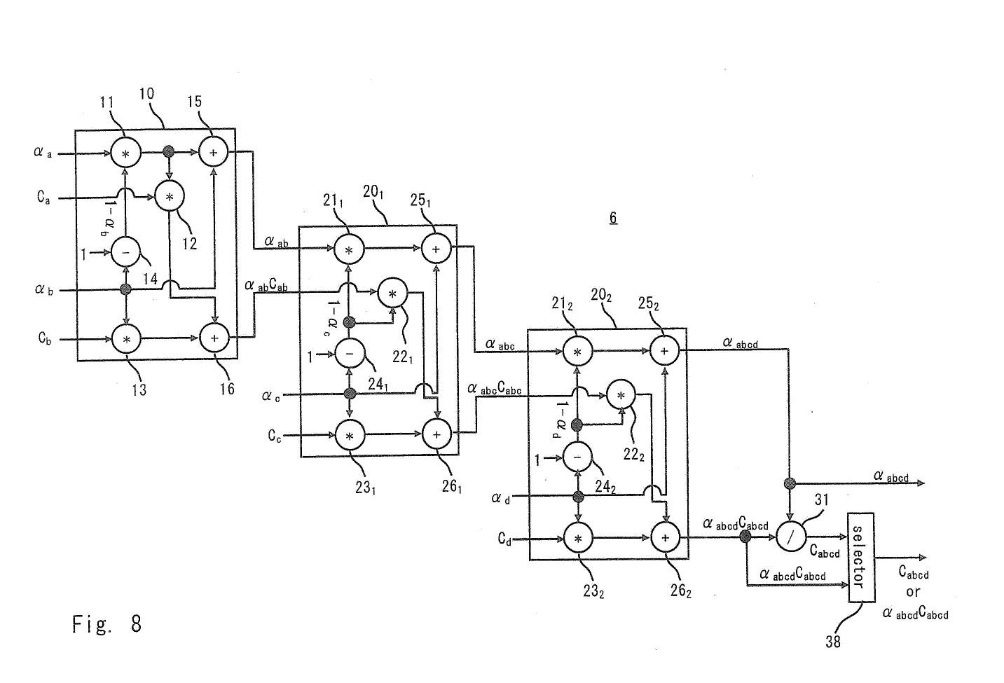

FIG. 8 is a block diagram of an image synthesizer 6 according to a sixth embodiment of the present invention. The image synthesizer 6 of the sixth embodiment includes a third selector (for example, selector 38) at the output of the image synthesizer 1 of the first embodiment. The selector 38 receives the pixel value C_{abcd} of the composite image output from the divider 31 and the alpha-multiplied pixel value α_{abcd}C_{abcd} output from the alpha blending computing unit 20₂. The selector 38 selects one of the received output values to output the selected one.

As a result, the image synthesizer 6 of the sixth embodiment can select one of the pixel value C_{abcd} and alpha-multiplied pixel value α_{abcd}C_{abcd} as an output value. Hence, the image synthesizer 6 can select and output a desired value in accordance with a function of a block connected to its output. That is, the image synthesizer 6 can enhance the flexibility of a system including the image synthesizer 6.

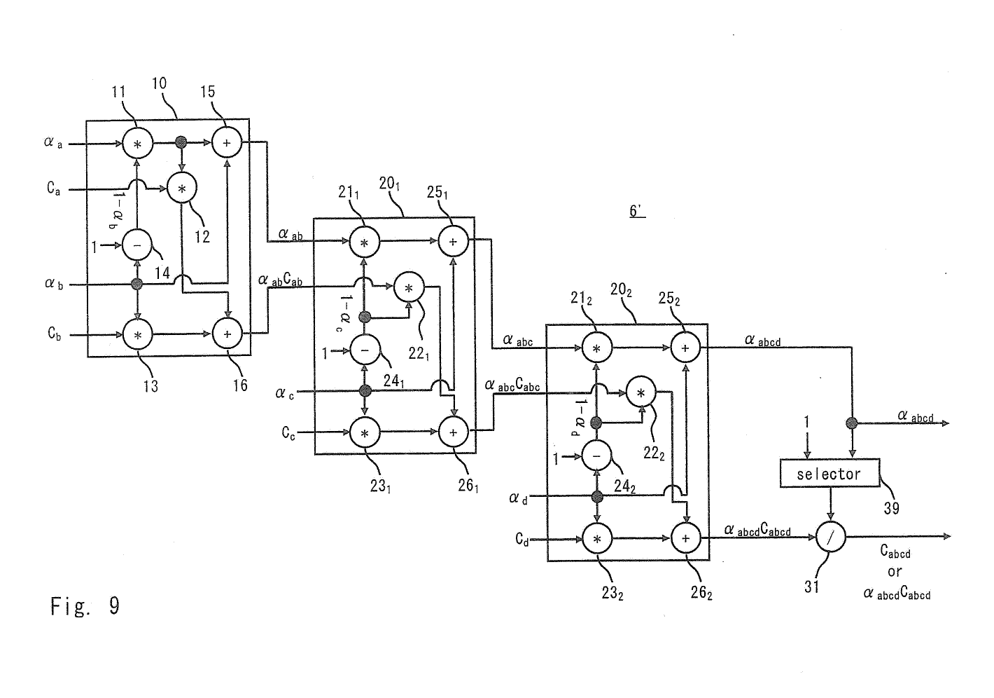

Further, FIG. 9 shows another example of the sixth embodiment. The image synthesizer 6′ of FIG. 9 includes a third selector (for example, selector 39) selecting an alpha value to be input to the divider 31. The selector 39 receives the value “1” and the alpha value α_{abcd} output from the alpha blending computing unit 20₂. The selector 39 selects and outputs one of the input values.

Here, if the selector 39 selects the alpha value α_{abcd}, the alpha value α_{abcd} is input to the divider 31, so the divider 31 outputs the pixel value C_{abcd} of the composite image. Further, if the selector 39 selects the value “1”, the divider 31 receives the value “1”, so the divider 31 outputs the alpha-multiplied pixel value α_{abcd}C_{abcd} of the composite image. That is, the image synthesizer 6′ can also select and output a desired value similar to the image synthesizer 6.

### Seventh Embodiment

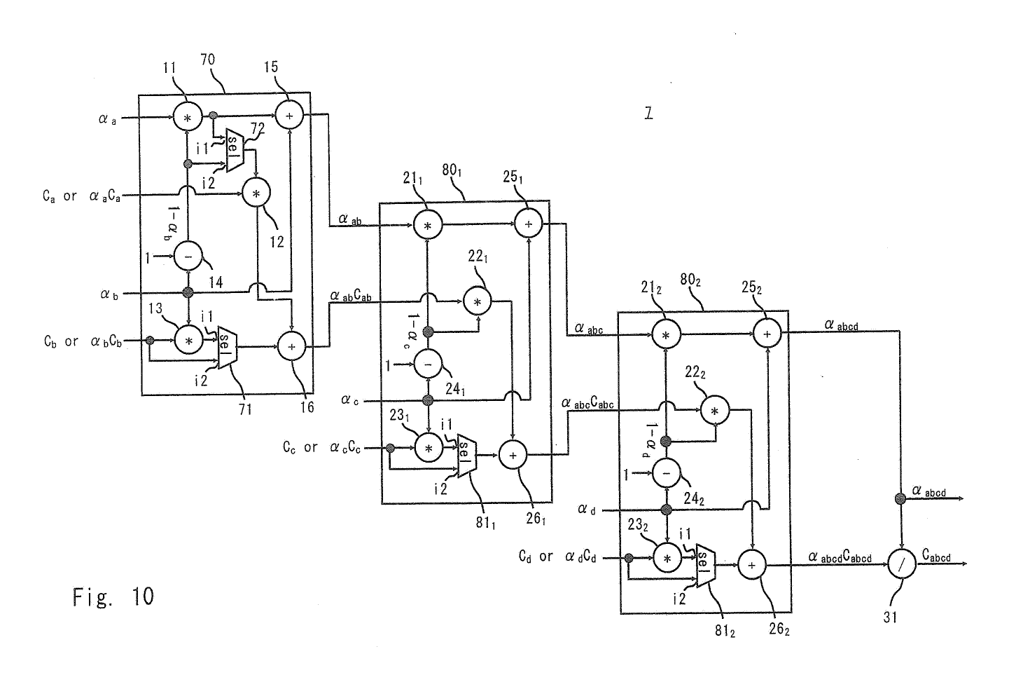

FIG. 10 is a block diagram of an image synthesizer 7 according to a seventh embodiment of the present invention. As shown in FIG. 10, the image synthesizer 7 of the seventh embodiment additionally includes a fourth selector inside the alpha blending computing unit of the image synthesizer 1 of the first embodiment. The alpha blending computing unit of this embodiment can thereby deal with the case where the pixel value or alpha-multiplied pixel value is input as image information.

The second computing unit of the image synthesizer 7 (for example, alpha blending computing unit 70) includes two fourth selectors (for example, selectors 71 and 72) in addition to the components of the second computing unit (for example, alpha blending computing unit 10) of the image synthesizer 1. Further, the first computing unit of the image synthesizer 7 (for example, alpha blending computing units 80₁ and 80₂) includes the fourth selectors (for example, selectors 81₁ and 81₂) in addition to the components of the first computing unit of the image synthesizer 1 (for example, alpha blending computing units 20₁ and 20₂).

How to connect the selectors 71 and 72 additionally provided in the alpha blending computing unit 70 is described next. The selector 71 includes input terminals i1 and i2, and selects and outputs one of values input to the input terminals i1 and i2. The input terminal i1 of the selector 71 is connected with an output of the multiplier 13, and the input terminal i2 receives the pixel value C or alpha-multiplied pixel value αC corresponding to the other input image. The selector 72 includes input terminals i1 and i2, and selects and outputs one of values input to the input terminals i1 and i2. The input terminal i1 of the selector 72 is connected with an output of the multiplier 11, and the input terminal i2 is connected with an output of the subtractor 14. If the selectors 71 and 72 select the value input to the input terminal i1, the connection form of the alpha blending computing unit 70 is the same as that of the alpha blending computing unit 10 of the first embodiment, and similar computation is carried out. On the other hand, if the selectors 71 and 72 select the value input to the input terminal i2, the connection form similar to the alpha blending computing units 80₁ and 80₂ as described below is adopted, and computation is carried out similarly thereto. That is, the alpha blending computing unit 70 can select a function of the first computing unit or the second computing unit.

How to connect the selector 81₁ added to the alpha blending computing unit 80₁ is described next. The selector 81₁ includes input terminals i1 and i2, and selects and outputs one of values input to the input terminals i1 and i2. The input terminal i1 of the selector 81₁ is connected with an output of the multiplier 23₁, and the input terminal i2 receives the pixel value C or alpha-multiplied pixel value αC corresponding to the other input image. If the selector 81₁ selects the value input to the input terminal i1, the connection form of the alpha blending computing unit 80₁ is the same as that of the alpha blending computing unit 20₁ of the first embodiment, and similar computation is carried out. On the other hand, if the selector 81₁ selects the value input to the input terminal i2, the input alpha-multiplied pixel value αC and the alpha value α corresponding to the alpha-multiplied pixel value αC are not multiplied. Here, the connection form of the selector 81₂ added to the alpha blending computing unit 80₂ is the same as that of the selector 81₁ added to the alpha blending computing unit 80₁, so its description is omitted here.

Operations of the image synthesizer 7 of the seventh embodiment are described next. First, similar to the image synthesizer 1 of the first embodiment, the case where the alpha value α and pixel value C are input as input image information is described. In this case, the selectors 71 and 72, and selectors 81₁ and 81₂ select the input terminal i1. Thus, the internal connection form of each alpha blending computing unit becomes the same as that of the alpha blending computing unit of the image synthesizer 1. Accordingly, an output value of the image synthesizer 7 is similar to that of the image synthesizer 1.

Meanwhile, the case where alpha value α and alpha-multiplied pixel value αC are input as the input image information is described. In this case, the selectors 71 and 72, and selectors 81₁ and 81₂ select the input terminal i2. Thus, the alpha blending computing units are connected not to multiply the input alpha-multiplied pixel value αC by the alpha value α corresponding to the alpha-multiplied pixel value αC. Accordingly, an output value of the alpha blending computing unit 70 is expressed by Expressions (25) and (26), an output value of the alpha blending computing unit 80₁ is expressed by Expressions (27) and (28), and an output value of the alpha blending computing unit 80₂ is expressed by Expressions (29) and (30).

$$\begin{matrix}{α}_{ab} = {α}_{b} + ( 1 - {α}_{b} ) * {α}_{a} & ( 25 ) \\ {α}_{ab} {C}_{ab} = {α}_{b} {C}_{b} + ( 1 - {α}_{b} ) * {α}_{a} {C}_{a} & ( 26 ) \\ \begin{matrix}{α}_{abc} = {α}_{c} + ( 1 - {α}_{c} ) * {α}_{ab} \\ = {α}_{c} + ( 1 - {α}_{c} ) * {α}_{c} + ( 1 - {α}_{c} ) * ( 1 - {α}_{b} ) * {α}_{a}\end{matrix} & ( 27 ) \\ \begin{matrix}{α}_{abc} {C}_{abc} = {α}_{c} {C}_{c} + ( 1 - {α}_{c} ) * {α}_{ab} {C}_{ab} \\ = {α}_{c} {C}_{c} + ( 1 - {α}_{c} ) * {α}_{b} {C}_{b} + ( 1 - {α}_{c} ) * ( 1 - {α}_{b} ) * {α}_{a} {C}_{a}\end{matrix} & ( 28 ) \\ \begin{matrix}{α}_{abcd} = {α}_{d} + ( 1 - {α}_{d} ) * {α}_{abc} \\ = {α}_{d} + ( 1 - {α}_{d} ) * {α}_{c} + ( 1 - {α}_{d} ) * ( 1 - {α}_{c} ) * {α}_{ab} \\ = {α}_{d} + ( 1 - {α}_{d} ) * {α}_{c} + ( 1 - {α}_{d} ) * ( 1 - {α}_{c} ) * {α}_{b} + \\ ( 1 - {α}_{d} ) * ( 1 - {α}_{c} ) * ( 1 - {α}_{b} ) * {α}_{a}\end{matrix} & ( 29 ) \\ \begin{matrix}{α}_{abcd} {C}_{abcd} = {α}_{d} {C}_{d} + ( 1 - {α}_{d} ) * {α}_{abc} {C}_{abc} \\ = {α}_{d} {C}_{d} + ( 1 - {α}_{d} ) * {α}_{c} {C}_{c} + ( 1 - {α}_{d} ) * ( 1 - {α}_{c} ) * \\ {α}_{ab} {C}_{ab} \\ = {α}_{d} {C}_{d} + ( 1 - {α}_{d} ) * {α}_{c} {C}_{c} + ( 1 - {α}_{d} ) * ( 1 - {α}_{c} ) * \\ {α}_{b} {C}_{b} + ( 1 - {α}_{d} ) * ( 1 - {α}_{c} ) * ( 1 - {α}_{b} ) * {α}_{a} {C}_{a}\end{matrix} & ( 30 )\end{matrix}$$

The values derived from the Expressions (29) and (30) become the same as the alpha value α_{abcd} and alpha-multiplied pixel value α_{abcd}C_{abcd} output from the alpha blending computing unit 20₂ of the first embodiment. Accordingly, the image synthesizer 7 of the seventh embodiment can obtain a value similar to the image synthesizer 1 of the first embodiment even if the alpha value α and alpha-multiplied pixel value αC are input as input image information.

As understood from the above description, according to the image synthesizer 7 of the seventh embodiment, even if the alpha-multiplied pixel value is input as an input image pixel value, the computational result similar to that of the first embodiment can be obtained. Further, even if the input image pixel value C is input like the first embodiment, the selector changes the internal connection form of the alpha blending computing unit to thereby obtain the output value similar to the first embodiment. That is, the image synthesizer 7 of the seventh embodiment selects a desired internal connection form of the alpha blending computing unit with the selector additionally provided inside the alpha blending computing unit to obtain the output value similar to the first embodiment regardless of input information.

### Eighth Embodiment

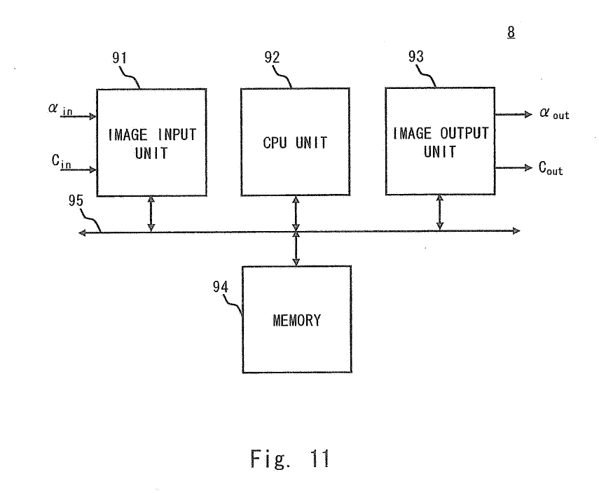

An image synthesizer 8 according to an eighth embodiment of the present invention executes computation of the image synthesizer 1 of the first embodiment by use of a general-purpose computer such as a CPU (Central Processing Unit). FIG. 11 is a block diagram of the image synthesizer 8. As shown in FIG. 11, the image synthesizer 8 includes an image input unit 91, a CPU unit 92, an image output unit 93, and a memory 94. Further, the image input unit 91, the CPU unit 92, the image output unit 93, and the memory 94 transmit/receive data through a data bus 95.

The image input unit 91 receives input image information and transmits the information to the memory 94 through the data bus 95. The CPU unit 92 synthesizes images based on the computation of the image synthesizer 1. The image output unit 93 outputs the image synthesized with the CPU unit 92 to, for example, a display device (not shown). The memory 94 stores information about the input images or composite image.

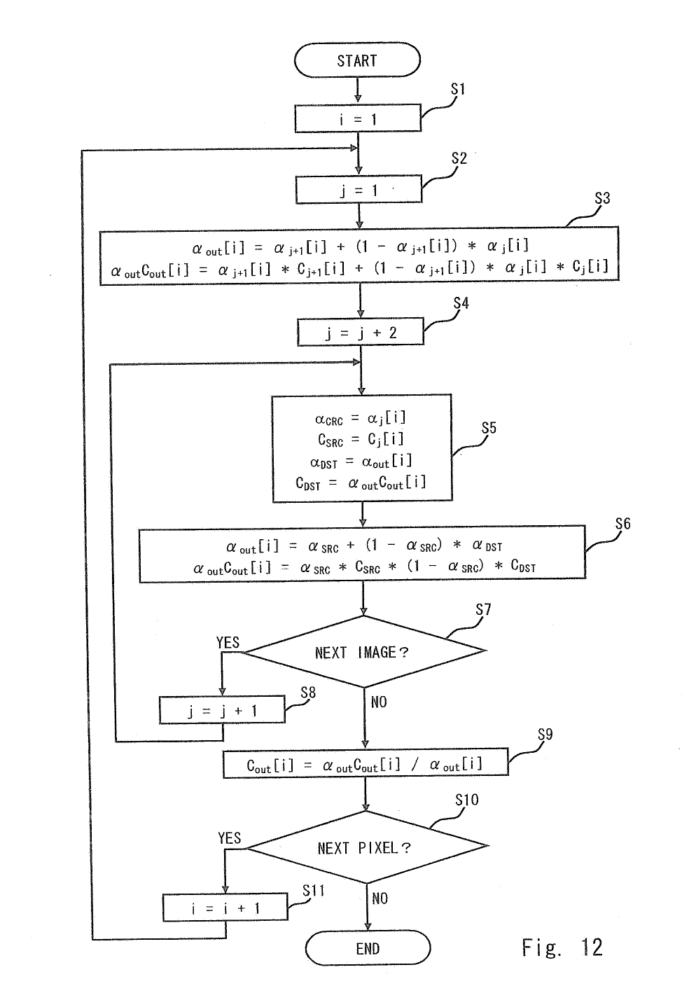

FIG. 12 is a flowchart of the computation executed with the CPU unit 92. Referring to FIG. 12, the computation of the CPU unit 92 is described next. Here, the pixel number of each of the images to synthesize is represented by i, and the image number is represented by j.

When image synthesis is started, the CPU unit 92 first initializes the pixel number i to 1 (step S1). Further, the image number j is initialized to 1 (step S2). Subsequently, an i-th pixel of a j-th image and an i-th pixel of a (j+1)th image are synthesized. Then, a second synthesizing step of calculating the alpha value αₒᵤₜ[i] and the alpha-multiplied pixel value αₒᵤₜCₒᵤₜ[i] of the i-th pixel obtained by synthesizing the j-th image and the (j+1)th image is executed (step S3). Here, the calculation in step S3 corresponds to the computation of the alpha blending computing unit 10 of the first embodiment. The calculation in step S3 is expressed by Expressions (31) and (32).
αₒᵤₜ[i]=αⱼ₊₁[i]+(1−αⱼ₊₁[i])*αⱼ[i] (31)
αₒᵤₜCₒᵤₜ[i]=αⱼ₊₁[i]*Cⱼ₊₁[i]+(1−αⱼ₊₁[i])*αⱼ[i]*Cⱼ[i] (32)

Subsequently, information on a (j+2)th image is read (step S4). At this time, the alpha value αₒᵤₜ[i] and alpha-multiplied pixel value αₒᵤₜCₒᵤₜ[i] obtained in step S3 are stored as an alpha value α_{DST} and a pixel value C_{DST}. Further, the alpha value αⱼ[i] and pixel value Cⱼ[i] of the (j+2)th image obtained in step S4 are stored as an alpha value α_{SRC} and a pixel value C_{SRC} (step S5). Next, based on the alpha value α_{DST} and pixel value C_{DST}, and the alpha value α_{SRC} and pixel value C_{SRC}, a first synthesizing step of calculating an alpha value αₒᵤₜ[i] and alpha-multiplied pixel value αₒᵤₜCₒᵤₜ[i] is carried out (step S6). Here, the calculation of alpha value αₒᵤₜ[i] and alpha-multiplied pixel value αₒᵤₜCₒᵤₜ[i] in step S6 corresponds to the computation of the alpha blending computing unit 20₁ of the first embodiment. The calculation in step S6 is expressed by Expressions (33) and (34).
αₒᵤₜ[i]=α_{SRC}+(1−α_{SRC})*α_{DST} (33)
αₒᵤₜCₒᵤₜ[i]—α_{SRC}*C_{SRC}+(1−α_{SRC})*α_{DST}*C_{DST} (34)

After the completion of the calculation in step S6, it is determine whether or not images remain to be synthesized (step S7). If it is determined that images remain to be synthesized in step S7, the next image is read under the condition that j=j+1 (step S8), and the processings of steps S5 and S6 are repeated The alpha value αₒᵤₜ[i] and alpha-multiplied pixel value αₒᵤₜCₒᵤₜ[i] calculated in these steps correspond to the values computed with the alpha blending computing unit 20₂ of the first embodiment. On the other hand, if there is no unsynthesized image, a dividing step of calculating a pixel value Cₒᵤₜ of a composite image to be output based on the calculation result in step S6 is executed (step S9). The calculation in step S9 corresponds to the computation of the divider 31 of the first embodiment. The computation is expressed by Expression (35).
Cₒᵤₜ[i]=αₒᵤₜCₒᵤₜ[i]/α_{out[i]} (35)

Subsequently, it is determine whether or not pixels remain to be synthesized (step S10). If it is determined that pixels remain to be synthesized in step S10, the next pixel is read under the condition that i=i+1, and the processings of steps S2 to S9 are repeated (step S11). On the other hand, if there is no unsynthesized pixel, the synthesizing processing is completed.

As understood from the above description, according to the image synthesizer 8 of the eighth embodiment, the processing executed with the alpha blending computing unit in the above embodiments can be carried out with a general-purpose computing unit such as a CPU.

Here, image synthesizing processing of a conventional alpha blending computing unit can be carried out with a general-purpose computing unit such as a CPU. However, the conventional alpha blending computing unit requires one divider for an output value of one alpha blending computing unit, so if the above processing is carried out with a general-purpose computing unit, the division takes more time to execute than the other computation, leading to a problem that images cannot be synthesized at high speeds.

In contrast, the image synthesizing processing of the eighth embodiment only needs to execute the division once after all images are synthesized. That is, the number of times the time-consuming division is executed is much smaller than the conventional one, so the image synthesizing processing can be performed at high speeds.

Here, even if a general-purpose computing unit carries out the processings executed in the embodiments other than the first embodiment, the computation flow is appropriately changed under the condition that the multiplier 32 of the second embodiment executes a multiplying step, the first and second selectors of the fifth embodiment execute first and second selecting steps, the third selector of the sixth embodiment executes a third selecting step, and the fourth selector of the seventh embodiment executes a fourth selecting step to thereby perform the processings with the general-purpose computing unit.

The above embodiments describe the example of synthesizing the four images. However, as another embodiment, for example, four or more images can be synthesized by changing the number of tandem-connected alpha blending computing units in accordance with the number of images to synthesize. Further, the above embodiments may be combined as appropriate.

It is apparent that the present invention is not limited to the above embodiment that may be modified and changed without departing from the scope and spirit of the invention.

What is claimed is:

1. An image synthesizer, comprising:
a plurality of computing units synthesizing first and second image information based on first and second factors corresponding to the first and second image information to output a third factor as a composition factor of the first and second factors and intermediate output information obtained by multiplying the third factor by third image information as composite image information of the first and second image information; and
a divider dividing the intermediate output information output from one of the plurality of computing units by the third factor to output the third image information,
at least one of the plurality of computing units serving as a first computing unit receiving intermediate input information obtained by multiplying the first image information by the first factor as input information corresponding to the first image information.

2. The image synthesizer according to claim 1, further comprising:
a second computing unit at a first stage, which receives the first and second image information and the first and second factors and outputs the third factor and the intermediate output information with the at least one first computing unit being connected in tandem with the second computing unit.

3. The image synthesizer according to claim 1, further comprising:
a multiplier at a first stage, which multiplies the first image information by the first factor to generate the intermediate input information with the at least one first computing unit being connected in tandem with the multiplier.

4. The image synthesizer according to claim 1, wherein the image synthesizer is provided with the first computing unit at a first stage, which does not receive image information and a factor as one input information and receives the first image information and the first factor as the other input information.

5. The image synthesizer according to claim 1, further comprising:
a first selector selecting the third factor output from one of the plurality of computing units; and
a second selector selecting the intermediate output information output from one of the plurality of computing units,
the divider dividing the intermediate output information selected with the second selector by the third factor selected with the first selector.

6. The image synthesizer according to claim 1, further comprising:
a third selector selecting and outputting one of the intermediate output information output from a computing unit at the last stage among the plurality of computing units and the third image information.

7. The image synthesizer according to claim 1, wherein at least one of the plurality of computing units includes a selecting unit determining whether or not to multiply the intermediate input information by the first factor corresponding to the intermediate input information.

8. An image synthesizing method, comprising:
executing a plurality of synthesizing processes of synthesizing first and second image information based on first and second factors corresponding to the first and second image information to output a third factor as a composition factor of the first and second factors and intermediate output information obtained by multiplying the third factor by third image information as composite image information of the first and second image information; and
dividing the intermediate output information output in one of the plurality of synthesizing processes by the third factor to output the third image information,
at least one of the plurality of synthesizing processes being a first synthesizing process receiving intermediate input information obtained by multiplying the first image information by the first factor as input information corresponding to the first image information.

9. The image synthesizing method according to claim 8, further comprising:
executing a second synthesizing process that receives the first and second image information and the first and second factors and outputs the third factor and the intermediate output information, followed by the at least one first synthesizing process.

10. The image synthesizing method according to claim 8, further comprising:
multiplying the first image information by the first factor to generate the intermediate input information, followed by the at least one first synthesizing process.

11. The image synthesizing method according to claim 8, wherein the first synthesizing process that does not receive image information and a factor as one input information and receives the first image information and the first factor as the other input information is executed first.

12. The image synthesizing method according to claim 8, further comprising:
executing a first selecting process of selecting the third factor output in one of the plurality of synthesizing processes; and
executing a second selecting process of selecting the intermediate output information output in one of the plurality of synthesizing processes,
the dividing including dividing the intermediate output information selected with the second selecting process by the third factor selected with the first selecting process.

13. The image synthesizing method according to claim 8, further comprising:
executing a third selecting process of selecting and outputting one of the intermediate output information output in the last synthesizing process among the plurality of synthesizing processes and the third image information.

14. The image synthesizing method according to claim 8, wherein at least one of the plurality of synthesizing processes includes a fourth selecting process of determining whether or not to multiply the intermediate input information by the first factor corresponding to the intermediate input information.
